(19) United States
(12) Patent Application Publication
(10) Pub. No.: US 2014/0065122 A1
(43) Pub. Date: Mar. 6, 2014

(54) Method for Removing a Microorganism Biofilm

(71) Applicants: Romain Briandet, Malakoff (FR); Alexandra Gruss, Orsay (FR); Stéphane Aymerich, Versailles (FR); Michel Gohar, Terce (FR); Julien Deschamps, Saint Cyr L'Ecole (FR); Ali Houry, Paris (FR)

(72) Inventors: Romain Briandet, Malakoff (FR); Alexandra Gruss, Orsay (FR); Stéphane Aymerich, Versailles (FR); Michel Gohar, Terce (FR); Julien Deschamps, Saint Cyr L'Ecole (FR); Ali Houry, Paris (FR)

(21) Appl. No.: 13/997,083

(22) PCT Filed: Dec. 16, 2011
(86) PCT No.: PCT/EP2011/073139

§ 371 Date: Nov. 15, 2013

(30) Foreign Application Priority Data
Dec. 21, 2010 (FR) 1060945

(51) Int. Cl. A01N 63/00

(52) U.S. Cl. CPC A01N 63/00
USPC 424/93.461; 424/93.1; 424/93.46; 424/93.462; 424/93.4

(57) ABSTRACT

The invention relates to a method for eliminating a biofilm of microorganism preexisting on an inert surface, characterized in that one subjects said biofilm to a cocktail of microorganisms comprising at least strains said to be “swimming” able to cross said biofilm in the plane and in the thickness, and one subjects said biofilm to at least one antimicrobial product directed against at least one microorganism of the biofilm to be eliminated.

### SCOPE OF THE INVENTION

The invention relates to a method for eliminating a biofilm of preexisting microorganisms through the use of specific microorganisms, known as swimmers, enabling, based on their movement in the biofilm, the creation of channels and holes through and in various layers of the biofilm. More particularly, the method according to the invention enables both the mechanical and biological destruction of the biofilm, the swimming microorganisms being combinable with an antimicrobial agent to do so.

The invention can be applied in all areas where the presence of microorganisms must be eliminated, be it in the agro-food sector, the medical sector, the industrial sector, and so on.

### PRIOR ART

Microorganisms, such as bacteria, yeasts, fungi, microalgae, and so on, organize themselves most frequently into biofilms when they colonize a surface, particularly inert ones (stainless steel, glass, and so on).

In a biofilm, the microorganisms are organized in successive layers forming a three-dimensional structure. There, the microorganisms are linked to each other and to the colonized surface. The microorganisms bathe in an extracellular matrix, synthesized at least in part by these same microorganisms.

The microorganisms of a biofilm exhibit increased resistance to antimicrobial treatments. This is explained in particular by the organization of the biofilm itself into superimposed layers, making the deepest layers difficult to access for antimicrobial agents. Similarly, the extracellular matrix tends to block the penetration of antimicrobial agents into the thickness of the biofilm. Furthermore, one has discovered that the gradients for pH, oxygen, nutrition, and so on, are created in the thickness of the biofilm. Also, one has observed that in certain layers of the biofilm, the microorganisms are in a state of senescence, thus increasing the phenomenon of resistance to antimicrobials.

Biofilms being prone to colonizing all surfaces, they may be the source of various types of food poisoning, nosocomial illnesses, and so on.

That is why one is attempting to prevent their formation or to eradicate them, be it by physical, chemical, or biological means.

Thus for example, one knows how to destabilize and at least partially eliminate biofilms by means of chemical treatments (detergents and/or disinfectants). Obviously, the use of these chemical compounds may be incompatible with certain applications, particularly due to the nature of the colonized environments. Furthermore, these agents do not always allow one to eliminate biofilms in their entire thickness and many biofilms exhibit a strong resistance to their action.

In certain cases, physical methods, such as temperature, ultrasound, gaseous plasmas, pulsed light, or photodynamic therapy and so on, may be used, but their industrial implementation is not always possible.

For certain applications, it is known to use bacteriophages to also eradicate certain microorganisms of the biofilm. However, their narrow specificity spectra, the presence of extracellular matrices, the organization into successive layers, and the phenomenon of senescence observed in certain layers favor the at least partial persistence of biofilms.

Thus, there is a real need to find new means to eradicate microorganism biofilms in a reliable manner.

### DESCRIPTION OF THE INVENTION

Observation and analysis of various microorganism biofilms have allowed inventors to discover within an already established biofilm of Bacillus thuringiensis on an inert surface, the existence of a subpopulation of microorganisms hereinafter referred to as “swimming microorganisms,” in the sense that these microorganisms have a kinetic energy such that they are able to move within the plane of the biofilm and in its thickness, even though the biofilm is already created. By moving, these swimming microorganisms create holes and channels locally and temporarily through different layers of the biofilm. It would seem that these holes and channels allow the transfer of microorganisms from one layer to another within the biofilm, as well as the irrigation and oxygenation of the biofilm and so on. Thus, certain strains of microorganisms have the ability to swim when they are in solution, which they partially maintain when they are organized in biofilms. In addition, these layers exhibit, most frequently when they are in solution, a swimming ability much greater than the swimming ability usually seen in microorganisms.

The inventors thus had the advantageous idea to take advantage of this swimming phenomenon to eliminate preexisting biofilms of microorganisms of any type.

Thus, the object of the invention is a method for eliminating a microorganism biofilm already created on an inert surface, characterized in that:
One subjects said biofilm to a cocktail of microorganisms comprising at least a population of microorganisms, said to be “swimmers,” whose kinetic energy is such that they are able to cross said biofilm within the plane and thickness, and
One subjects said biofilm to at least one antimicrobial product directed against at least one microorganism of biofilm to be eliminated. The stage when the biofilm is treated with the antimicrobial products may be simultaneous or after the stage when the biofilm is treated with the microorganism cocktail containing swimming microorganisms.

An already created or preexisting biofilm of microorganisms refers to a group of microorganisms, heterogeneous or homogeneous, organized in several successive layers, connected amongst themselves and/or to the colonized surface, and surrounded by an extracellular matrix. The biofilm to be eliminated may also be a biofilm composed solely of bacteria, or fungus, or yeast, or protozoa, and so on, these microorganisms also being able to be of the same species or different species, or a biofilm composed of at least two microorganisms of different types.

Inert surface refers in particular to surfaces of stainless steel, glass, polymers, wood, tiles, and so on, and more generally any surface other than a biological, human, animal or vegetable surface.

Thus the method according to the invention may be used along the entire food production chain (farming and processing), in particular for the treatment of surfaces with which said foods are likely to be in contact, in order to eliminate all risk of food poisoning. Similarly, the method according to the invention enables one to eliminate biofilms that are present on medical devices so as to limit the risks of nosocomial infection after their use.

The stage of subjecting the biofilm to the microorganism cocktail consists for example of placing said biofilm in contact with said cocktail. For example, one places the desired quantity of the microorganism cocktail on the inert surface to be treated. The microorganism cocktail is preferably a bacteria cocktail.

Swimming microorganisms refer to motile microorganisms, held in suspension in the cocktail, whose kinetic energy is such that they are able to move both in the plane of said biofilm and its thickness, namely to cross all successive layers of said biofilm, despite the strong intercohesion among the microorganisms and the presence of the extracellular matrix, whose viscosity tends to immobilize microorganisms.

The kinetic energy that the microorganism must at least have to be able to move in a biofilm in all directions depends on the particular characteristics of this biofilm. For each biofilm having given characteristics, the microorganisms exhibiting a swimming capability according to the present invention, namely able to move in the plane and in the thickness in said biofilm, may be identified in an experimental manner. In particular, this may be accomplished by using a confocal microscope to observe any movement of different microorganisms put in contact with the biofilm, and by selecting strains for which one observes the formation of holes and channels in the biofilm layers, attesting to the microorganism's ability to swim in said layers.

For most of the microorganism biofilms currently encountered, the microorganisms, exhibiting a motility disk, after 24 hours of incubation at 37° C., of a diameter exceeding 30 mm in the 0.25-percent agar motility test as described below, have a kinetic energy sufficient to exhibit a swimming capability, according to the present invention, in the biofilm. Such microorganisms generally exhibit a displacement speed in the culture of at least equal to 10 μ/sec.

Preferably, the swimming microorganisms are swimming bacteria.

The use of swimming microorganisms, able not only to move within the same layer but also able to cross through all layers of the biofilm to be eliminated, namely the entire thickness of said biofilm, enables one to destabilize and fluidify the three-dimensional structure of said biofilm.

Preferably, one subjects the biofilm to be eliminated to a cocktail of swimming microorganisms for a time period between 30 minutes and 10 hours. When the microorganism cocktail is removed from the inert surface, a large number of swimming microorganisms remain with the biofilm in which they infiltrated themselves, and continue to destabilize it.

The microorganism cocktail used may also comprise at least an antimicrobial product directed against at least a microorganism of the biofilm to be eliminated. Said antimicrobial product may interfere in the entire biofilm and reach all layers, even the deepest and normally inaccessible ones. With the antimicrobial compound acting on the target microorganisms of all biofilm layers, it thus becomes possible to eliminate it in its entirety.

Alternatively, the biofilm may be treated with an antimicrobial product, once the cocktail of swimming microorganisms is removed. Said antimicrobial compound is for example deposited on the inert surface previously treated with the microorganism cocktail. The antimicrobial compound may thus infiltrate all layers of the biofilm and act on each one of them.

The counteraction of the antimicrobial compound against even only one type of microorganism, in the case of a biofilm composed of various microorganisms, allows one to destabilize the biofilm in its entire thickness, and to lead to its elimination.

According to an example of implementing the invention, one anticipates using swimming microorganisms able to synthesize at least one antimicrobial product directed against at least one microorganism of the biofilm to be eliminated. Thus in the microorganism cocktail, one uses strains known as swimmers able to synthesize at least one such antimicrobial product.

Then, the synthesized antimicrobial compound is released locally within the biofilm, among all biofilm layers. Even the deepest layers may be reached, even though they are otherwise inaccessible to antimicrobial compounds. The antimicrobial compound thus acts on the target microorganisms of all the biofilm layers.

Obviously, it is possible to utilize a swimming microorganism synthesizing several different antimicrobial compounds and/or several types of swimming microorganisms synthesizing different antimicrobial compounds. It is easily possible to adapt the sample group of swimming microorganisms and antimicrobial compounds produced as a function of the microorganisms to be eliminated.

Such microorganisms may be microorganisms naturally synthesizing an antimicrobial product directed against all or part of the target microorganisms. Alternatively, these microorganisms may be recombinant microorganisms in which a gene of interest, coding the desired antimicrobial compound, is integrated.

In addition, it is possible to combine swimming microorganisms of the microorganism cocktail with microorganisms said to be “non-swimming”, such as bacteria said to be “non-swimming”, or any other microorganism, able to synthesize at least one antimicrobial product directed against at least one microorganisms of the biofilm to be eliminated. In the preferred implementation modes of the invention, the microorganism cocktail used also comprises strains known as non-swimming, able to synthesize at least one such antimicrobial product.

Non-swimming microorganisms synthesizing the antimicrobial component(s) may also be used later, namely after pretreating the inert surface with the microorganism cocktail comprising swimming microorganisms. For example, one subjects the thusly pretreated inert surface to a second microorganism cocktail that comprises non-swimming microorganisms synthesizing antimicrobial compounds. The pretreatment refers to the placement into contact with the swimming microorganism cocktail, followed after a specified amount of time with rinsing of the surface in order to eliminate said swimming microorganism cocktail.

Thus, according to the preferred implementation modes of the invention, one subjects the biofilm treated by the microorganism cocktail to a second microorganism cocktail comprising at least “non-swimming” strains able to synthesize at least one antimicrobial product directed against at least one microorganism of the biofilm to be eliminated.

Non-swimming microorganisms refer to microorganisms whose kinetic energy is not sufficient for them to be able to move in the plane and/or the thickness of the biofilm in a manner to create holes and channels in it.

In this case, the swimming microorganisms may advantageously synthesize a different antimicrobial product, but may also synthesize the same antimicrobial product, or even no antimicrobial product.

Swimming microorganisms, which themselves produce antimicrobial compounds or not, create holes and channels in the biofilm, promoting the penetration and distribution of non-swimming microorganisms producing antimicrobial compounds throughout the entire biofilm. One thereby enables activity of the antimicrobial compound(s) in all layers of the biofilm.

In addition, the microorganism cocktail may comprise, in addition to swimming microorganisms, an exogenous antimicrobial, directed against at least one microorganism of the biofilm to be eliminated.

Any antimicrobial that is not harmful to the swimming microorganisms of the microorganism cocktail may be used.

The inert surface may alternatively be treated with the exogenous antimicrobial, after pretreating said surface with the microorganism cocktail. For example, one subjects the inert pretreated surface to a solution comprising the desired antimicrobial.

In the preferred implementation modes of the invention, one thus subjects the biofilm, previously treated with the microorganism cocktail comprising swimming strains, to at least one biological or chemical antimicrobial directed against at least one microorganism of the biofilm to be eliminated.

Advantageously, the swimming microorganisms of the microorganism cocktail used are selected from the Bacillus thuringiensis, Bacillus subtilis, Bacillus licheniformis, Bacillus cereus, and Serpens flexibilis bacteria. The strains that exhibit a motility disk having a diameter greater than 30 mm in the 0.25% agar motility test described below have a swimming capability, according to the present invention, in most of the biofilms currently encountered.

The concentration of swimming microorganisms in the microorganism cocktail used is to be adjusted as a function of the strains utilized.

In the particularly preferred implementation modes of the invention, in terms of efficiency in eliminating the preexisting microorganism films on an inert surface, the microorganism cocktail comprises at least a first strain of larger, more slow-moving swimming microorganisms in the biofilm, and a second strain of smaller and faster-moving microorganisms in the biofilm.

This means that the microorganisms of the first strain have a bigger size and a slower displacement speed in the biofilm than the microorganisms of the second strain.

The present inventors discovered that the combined implementation of two strains of swimming microorganisms having such differences in characteristics enabled one to obtain a synergistic effect for eliminating biofilm, with the effect being the fastest and most complete elimination of said biofilm.

One will not prejudge here the mechanisms that underlie such an advantageous outcome. However, one can imagine that the bigger microorganisms create large channels in the biofilm, these large channels facilitating displacement in the biofilm of the fastest microorganisms, whose effect is to accelerate and intensify the mechanical destabilization of the biofilm, and consequently to promote irrigation and diffusion of the antimicrobial product throughout the volume of the biofilm.

In the advantageous implementation modes of the invention, the ratio of the size of the swimming microorganisms of the first strain to the size of the swimming microorganisms of the second strain is greater than or equal to 1.5. It is preferably about equal to 2.

The ratio of the speed of displacement in the biofilm of swimming microorganisms of the second strain to the speed of displacement in the biofilm of swimming microorganisms of the first strain is preferably greater than or equal to 1.5, and preferably about equal to 2.

Selecting such characteristics allows one to advantageously obtain an even greater efficiency in eliminating the biofilm.

The first swimming strain and the second swimming strain may belong to the same species or to different species.

In particular, in implementation modes of the invention, the first strain belongs to the Bacillus thuringiensis species and the second strain belongs to the Bacillus licheniformi species.

The microorganism cocktail may also comprise more than two swimming strains, stemming from the same species or different species.

In other implementation modes of the invention, the first strain of swimming microorganisms and the second strain of swimming microorganisms are implemented successively, namely placed in contact with the biofilm to be eliminated one after the other, preferably at an interval of several minutes. Accordingly, one first subjects said biofilm to a microorganism cocktail comprising one of these swimming strains, then one subjects the biofilm to the other of these swimming strains. In such an implementation mode, it is absolutely advantageous to implement the first strain, which has a bigger size, before the second strain, which can move faster in the biofilm.

### BRIEF DESCRIPTION OF THE DRAWINGS

FIGS. 1A and 1B depict views, obtained using a confocal laser scanning microscope (CLSM) of a biofilm of Bacillus thuringiensis genetically marked with green fluorescent protein (GFP), in which one can see channels (FIG. 1A) and holes (FIG. 1B), formed in the biofilm by sub-populations of swimming Bacillus thuringiensis within the biofilm.

FIGS. 1C and 1D each schematically represent the trajectory completed in 80 seconds by a swimming Bacillus thuringiensis bacterium in two 48-hour biofilms of Bacillus thuringiensis.

FIGS. 1A, 2B, and 2C depict the motility disk of motile strains of Bacillus subtilis 168 pWG200 (FIG. 2A), Bacillus thuringiensis 407 (FIG. 2B) and Bacillus thuringiensis 407 pHT50 (FIG. 2C) in a motility test in 0.25% agar and FIGS. 20, 2E and 2F depict the motility disk of non-motile strains of Bacillus subtilis 168 Δfla pWG200 (FIG. 2D), Bacillus thuringiensis 407 Δfla (FIG. 2E) and Bacillus thuringiensis 407 Δfla pHT50 (FIG. 2F) in this same motility test.

FIGS. 3A to 3E depict a confocal microscopic view of a Staphylococcus aureus biofilm in the presence or not of a cocktail of swimming bacteria, producing or not an antimicrobial product; thus, FIG. 3A depicts a Staphylococcus aureus biofilm genetically marked only with GFP; FIG. 3B depicts a Staphylococcus aureus biofilm marked with GFP to which one has added a cocktail of microorganisms contain swimming Bacillus thuringiensis bacteria; FIG. 3C depicts a biofilm of Staphylococcus aureus marked with GFP to which one has only added the filtrate of the microorganism cocktail containing Bacillus thuringiensis bacteria that has been genetically modified to produce lysostaphin; FIG. 3D depicts a biofilm of Staphylococcus aureus labeled with GFP to which one has added a microorganism cocktail containing motile Bacillus thuringiensis bacteria that has been genetically modified to produce lysostaphin; FIG. 3E depicts a biofilm of Staphylococcus aureus labeled with GFP to which one has added a microorganism cocktail containing Bacillus thuringiensis bacteria that have been genetically modified so as to not be swimmers and to produce lysostaphin.

FIG. 4 is a graph showing the quantification of the biovolume in μm³ of a residual biofilm of Staphylococcus aureus in the absence of a cocktail of swimming microorganisms (target biofilm St), in the presence of a cocktail of swimming microorganisms Bacillus thuringiensis (Bt), a cocktail of non-swimming microorganisms Bacillus thuringiensis 407 Δfla (Bt Δfla), a cocktail of swimming, lysostaphin-producing microorganisms Bacillus thuringiensis 407 pHT50 (Bt Lys) and a cocktail of non-swimming, lysostaphin-producing Bacillus thuringiensis 407 Δfla pHT50 (Bt Δfla Lys).

FIG. 5 is a graph depicting in parallel the effect of a biofilm of Staphylococcus aureus being treated by a cocktail of microorganisms comprising swimming bacteria Bacillus thuringiensis not producing any antimicrobial product, in combination with an antimicrobial compound, lysostaphin (used here in a range from 0 to 0.5 μg/ml) and the effect of a treatment of a Staphylococcus aureus biofilm with only one antimicrobial compound, lysostaphin (used in the same range from 0 to 0.5 μg/ml).

FIG. 6 is a graph depicting in parallel the effect of a biofilm of Staphylococcus aureus being treated by a cocktail of microorganisms comprising swimming bacteria Bacillus thuringiensis not producing any antimicrobial product, in combination with a non-swimming microorganism producing an antimicrobial product, the strain Bacillus thuringiensis 407 Δfla pHT50 (used here in a concentration range of 6 to 8 logarithmic units per ml), and the effect of treating a same biofilm of Staphylococcus aureus with only one non-swimming microorganism producing antimicrobial compounds, the strain Bacillus thuringiensis 407 Δfla pHT50 (used here in the same concentration range).

FIG. 7 is a graph depicting the reduction log of a biofilm of untreated Staphylococcus aureus or treated with a strain of non-swimming bacteria Bacillus thuringiensis 407 Δfla (BtΔfla, negative control), or by a strain of swimming bacteria Bacillus thuringiensis 407 (Bt), or by a strain of swimming bacteria Bacillus licheniformis LMG7560 (Bl), or by a mixture of the two swimming strains Bt and Bl at equal concentrations, this pretreatment being followed by a treatment with the biocide benzalkonium chloride at a concentration of 750 ppm.

### EXPERIMENTS

1—In Vitro Identification Test for Swimming Microorganisms

For most of the biofilms, it is possible to determine if a microorganism is a swimming microorganism according to the invention, for example by means of a microbial motility test in agar, of which a detailed example is described below.

The principle of the test consists of inoculating, at the center of a Petri dish filled with semi-liquid gel (0.25% agar), a small quantity of microorganisms (−10⁶ cells) and after an incubation period of measuring the size of the disk formed in the Petri dish.

Equipment and Method

The test is described here for a series of Bacillus subtilis and Bacillus thuringiensis and their non-motile mutants (strains described in Table I below). The swimming capability of the strains is determined in the Petri dishes having a diameter of 9 cm, filled with a Luria-Bertani culture medium (LB, Difco, reference no. 244620) supplemented with 0.25% agar.

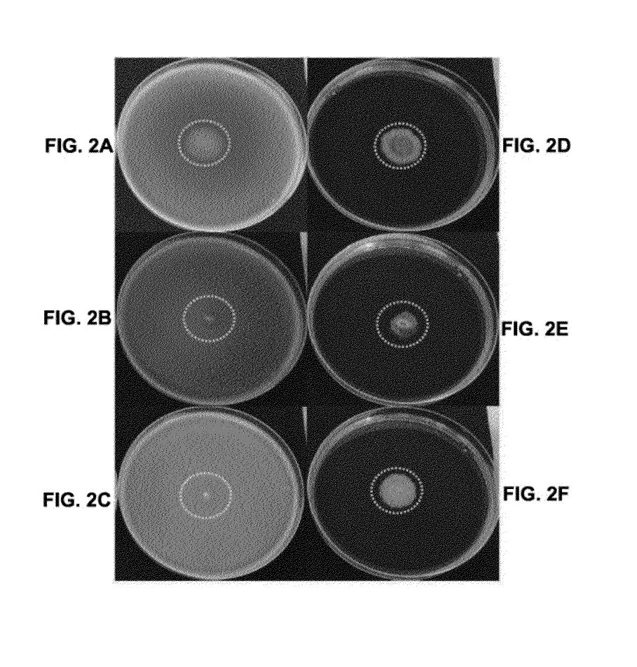

Six different strains were tested here, three swimming strains, namely Bacillus subtilis 168 pWG200 (FIG. 2A), Bacillus thuringiensis 407 (FIG. 2B), Bacillus thuringiensis 407 pHT50 (FIG. 2C), and three non-swimming strains, namely Bacillus subtilis 168 Δfla pWG200 (FIG. 20), Bacillus thuringiensis 407 Δfla (FIG. 2E) and Bacillus thuringiensis 407 Δfla 20 pHT50 (FIG. 2F).

The strains were previously cultivated in the LB medium (without adding agar) at 37° C. for 15 hours.

A deposition of 5 μL of culture at approximately 2.10⁸ UFC/ml was then made at the center of each Petri dish, or approximately 10⁶ UFC.

The dishes were then incubated for 24 hours at 37° C., and then the diameter of the microbial disk obtained was measured using a ruler.

Results and Interpretation

The microbial disks obtained are depicted in FIGS. 2A to 2F.

Under these experimental conditions and for the tested microorganisms, a disk with a diameter greater than 30 mm indicates a high ability to move in a viscous medium (a 30-mm circle is represented by a dotted line in the figures).

Thus, one observes that the propagation of the microbial layer for certain strains is at least equal to 30 mm (FIGS. 2A, 2B and 2C), while for other strains, the propagation of the microbial layer is much less than 30 mm (FIGS. 20, 2E and 2F) under test conditions.

The test is presented here for Bacillus, however it could easily be adapted to other microorganisms by manipulating the nature of the culture medium, the agar concentration, as well as the incubation time and temperature.

2—Identifying Swimming Microorganisms within a Biofilm of Bacillus Thuringiensis

A Bacillus thuringiensis biofilm was observed using confocal laser scanning microscopy. This method enables one to maintain the integrity of the biofilm and to observe any structural and physiological changes in all dimensions of said biofilm.

Equipment and Method

The strain used for this procedure is Bacillus thuringiensis, naturally equipped with a swimming ability and genetically marked with GFP (green fluorescent protein). The strain is stored in cryotubes at −80° C. in 20% glycerol. After two precultures, the strain is seeded to one-thousandth in 10 mL of Luria-Bertani culture medium (LB, Difco, reference no. 244620) and incubated at 30° C. for 15 hours while stirring (180 rpm).

The biofilms were cultivated at 30° C. in dedicated FC81 flow chambers (Biosurface Technologies Corporation, Bozeman, USA). To initiate growth of the biofilm, 2 ml of culture in an exponential phase diluted to a DO₆₀₀ of 0.01 are injected into the flow chamber. After one hour of adhesion, a constant 27-ml/hour flow of the LB culture medium is applied in the chamber using a peristaltic pump (Watson-Marlow 205S Watson-Marlow Ltd, Falmouth, England). The biofilm is thus cultivated at 30° C. for 48 hours, after which the individual cellular movements are observed by means of confocal laser scanning microscopy (Leica SP2 AOBS, MIMA2 imaging platform). The fluorescence of the GFP is generated by exciting a laser at 488 nm through a ×63 immersion lens and it is collected in the 500-600-nm range on a photomultiplier. The swimming of the cells is detected by the acquisition of image sequences over a period of time (one image every 1.6 sec for several tens of seconds).

Results and Interpretation

Observing this biofilm enables one to highlight, among all of the bacteria forming this biofilm, the presence of motile bacteria with a strong displacement capability, or swimming bacteria. Thus, these bacteria have a displacement speed of approximately 57,000 μm/hr and can move, in a random manner, throughout the entire biofilm by crossing it from end to end.

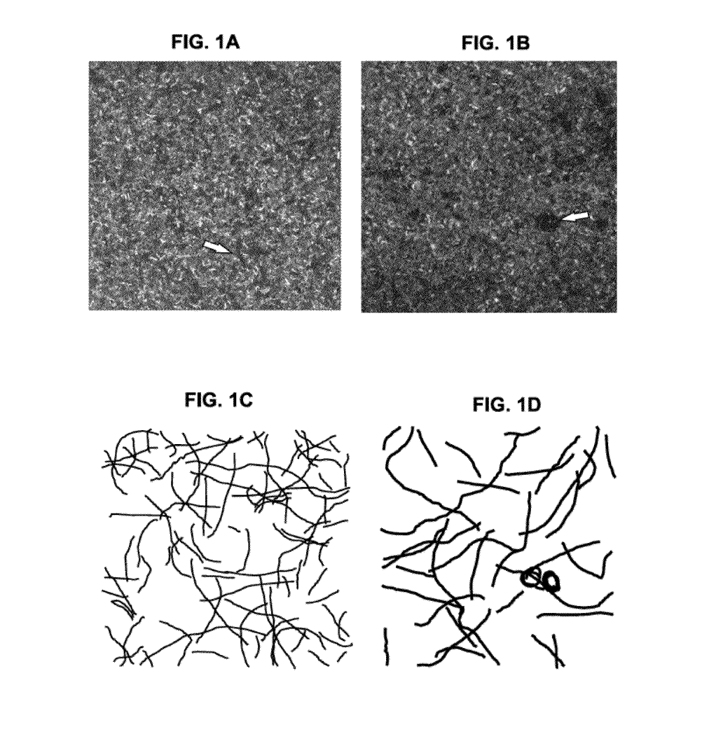

These bacteria transitionally form channels (FIG. 1A) and holes (FIG. 1B), of a macroscopic nature, through several layers, and which do not close immediately.

These movements are related to the propulsive force of the flagella of said bacteria. In fact, a biofilm of mutant Bacillus thuringiensis without flagella or paralyzed flagella does not exhibit such movements.

These very high-motility bacteria change their trajectory as soon as they encounter an obstacle, which allows one to foresee their potential in exploring the entire biofilm.

In FIGS. 1C and 1D, one has depicted the trajectory of such bacteria with a high degree of movement capability in a 48-hour biofilm over a period of only 80 seconds. These portrayals clearly illustrate the high movement potential of such bacteria in a biofilm.

In addition, the movement potential of these bacteria Bacillus thuringiensis with a high displacement capability were tested in biofilms comprised of other microorganisms. One was thus able to observe that these bacteria kept their movement capability in numerous biofilms of Gram-positive bacteria (Staphylococcus aureus, Entereococcus faecalis, Listeria monocytogenes, etc.) and Gram-negative bacteria (Yersinia enteritidis). This same displacement capability was also observed in Bacillus subtilis.

### Examples of Implementing the Method According to the Invention

### 1—Example 1

### Eliminating a Biofilm of Staphylococcus Aureus by Means of a Microorganism Cocktail Comprising Swimming Bacteria Bacillus Thuringiensis Producing Lysostaphin

In this example, the intent was to highlight the effect of a swimming bacteria producing a compound toxic on an undesirable biofilm.

The interaction model presented is that of the dissolution of 24-hour biofilms of Staphylococcus aureus RN4220 genetically marked with fluorescent GFP by motile strains of Bacillus thuringiensis producing lysostaphin, an autolysine specific to Staphylococcus aureus. The strain Bacillus thuringiensis 407 pHT50 and its non-motile mutant were developed for the requirements of these experiments.

Material and Method

A—Strains and Culture Conditions

The bacteria strains used in this experiment are listed in Table I below. The strains are kept at −80° C. in a solution of 20% glycerol.

TABLE I
Strains used

| Strains | Code | Properties | Reference |
|---|---|---|---|
| Staphylococcus aureus | Sa | Target pathogen forming | Malone et al. 2009 |
| RN4220 | | biofilms and revealing | |
| | | the GFP fluorescent | |
| | | protein, resistance to | |
| | | erythromycin at 10 μg/ml | |
| Bacillus thuringiensis | Bt | Swimmer; non- | Salamitou et al. 2000; |
| 407 | | production of toxic | Houry et al, |
| | | compounds | 2010 |
| Bacillus thuringiensis | Bt Δfla | Genetic inactivation of | Houry et al, 2010 |
| 407 Δfla | | the swimming capability, | |
| | | non-production of toxic | |
| | | compounds | |
| Bacillus thuringiensis | Bt Lys | Swimmer producing | Obtention method below |
| 407 pHT50 | | lysostaphin, resistance | |
| | | to tetracycline at 10 μg/ml | |
| Bacillus thuringiensis | Bt Δfla Lys | Genetic inactivation of | Obtention method below |
| 407 Δfla pHT50 | | the swimming capability | |
| | | and production of | |
| | | lysostaphin, resistance | |
| | | to tetracycline at 10 μg/ml | |

Genetic Construction of Lysostaphin-Producing Strains (Bacillus Thuringiensis 407 ΔFla pHT50 and Bacillus thuringiensis 407 ΔFla pHT50):

The coding gene for lysostaphin was amplified by PCR based on the plasmide pWG200 (Gaier et al., 1992) by introducing restriction sites XhoI in 5′ and XbaI in 3′.

The developer papha3 of gene apha3 was amplified by PCR based on plasmide pDG783 (Guerout-Fieury et al., 1995) by introducing restriction sites Eco RI in 5′ and XhoI in 3′.

The obtained fragments were digested by XhoI and XbaI or by EcoRI and XhoI and ligated in plasmide pHT1618 (Lereclus et al., 1992) opened by Eco RI and XbaI.

The obtained plasmide, resistant to tetracycline and carrying the lysostaphin gene under the control of developer papha3, is called pHT50. The wild Bacillus thuringiensis 407 strains and Δfla (Houry et al., 201 0) were transformed by electroporation by the plasmide pHT50 and selected on the Petri dish.

B—Formation of Staphylococcus Aureus GFP Target Biofilms.

The method used for forming the target biofilms was drawn from the one described in the article by Bridier et al. 2010.

A preculture of Staphylococcus aureus RN4220 GFP was created by inoculating 1 cryotube of 1 mL of the strain in 9 mL of TSB (Biomérieux, reference no: 51 019), at 37° C., while stirring at 180 rpm for 8 hours.

The culture was created by inoculating 10 μL of preculture in 10 mL of culture medium at 37° C., while stirring at 180 rpm for 15 hours.

The bacterial concentration was then adjusted to about 10⁷ cells/mL by adjusting the visual density to 600 nm of the suspension at 0.01 in TSB.

In a 96-well microplate (GreinerBioOne, μClear, reference no. 655090), one inoculates 250 μL of the adjusted Staphylococcus aureus GFP suspension in each well and one incubates the microplate for 1 hour at 37° C. to allow initial adhesion of the cells.

The non-adhering cells are then eliminated by renewing the culture medium in each well with 250 μL of sterile TSB.

The microplate is then incubated at 37° C. for 24 hours, which enables the formation of 96 biofilms of Staphylococcus aureus GFP having a thickness at least equal to 30 μm.

C—Interaction with a Cocktail of Microorganisms Comprising Bacillus thuringiensis.

An initial preculture of the two strains of Bacillus thuringiensis (Bacillus thuringiensis 407 pHT50, Bacillus thuringiensis 407 Δfla pHT50) is created by inoculating 1 cryotube of 1 mL in 9 mL of LB medium (Difco, reference no.: 10 244620) that one incubates for 15 hours at 37° C., while stirring at 180 rpm.

A second preculture is created by placing 10 μL of the second preculture in 10 mL of the culture medium for 8 hours at 37° C., while stirring at 180 rpm. The culture is then obtained by inoculating 100 μL of the second preculture in 10 mL of the culture at 37° C. while stirring at 180 rpm for 15 hours.

The cellular concentration of the Bacillus thuringiensis (Bacillus thuringiensis 407 pHT50, Bacillus thuringiensis 407 Δfla pHT50) suspensions is adjusted in LB with a spectrophotometer set at D0₆₀₀ₙₘ=0.02 (or approximately 2.10⁶ cells/mL).

5 mL of the suspensions are sterilized by filtration with 0.22-μm filters (Syringe Filter Nalgene®, Cat no. 190-2520) to harvest the sterile supernatants of the cultures that will later serve as controls.

On the microplate containing the 96 biofilms of 24-hour Staphylococcus aureus RN4220 GFP having a thickness of 30 μm, the supernatants of each well are delicately removed (by removing 250 μL with a micropipette).

250 μL of the calibrated suspensions of Bacillus thuringiensis 407 pHT50 are added to 18 wells.

250 μL of the calibrated suspensions of sterile supernatants of Bacillus thuringiensis 407 pHT50 are added to 18 other wells.

250 μL of calibrated suspensions of Bacillus thuringiensis 407 Δfla pHT50 are added to 18 other wells.

250 μL of calibrated suspensions of sterile supernatants of Bacillus thuringiensis 407 Δfla pHT50 are added to 18 other wells.

The 24 remaining wells are simply renewed with a sterile culture medium and serve as controls for non-treated target biofilms.

The microplate is then incubated for 1 hour at 37° C. to allow the initial interaction between the preparations and the target biofilms. A renewal of the culture medium of all wells is then performed with 250 μL of the LB medium.

After 24 hours of incubation at 37° C. without stirring the plate, the 10 residual biofilms of Staphylococcus aureus GFP are analyzed using a confocal laser scanning microscope (CLSM) according to the method described by Bridier et al 2010.

It is possible to visualize and to quantify the biovolume of the pathogen cells of the residual biofilm in the presence or not of biological treatment, and thus quantitatively evaluate the efficiency of the method for eliminating the target biofilm.

For example, one creates 3D projections of the structure of the biofilms using the easy 3D function of the Imarls 7.0 software program (Bitplane, Switzerland). Then, one determines the biovolume of the residual target biofilms based on a series of confocal images obtained with the Matlab PHLIP tool as described in the article by Bridier et al. 2010.

Interpretation of the Results

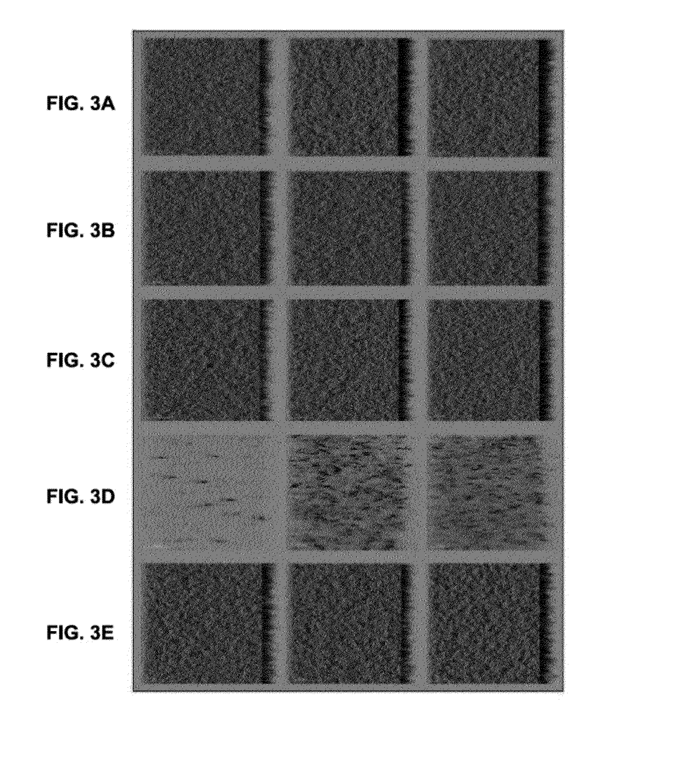

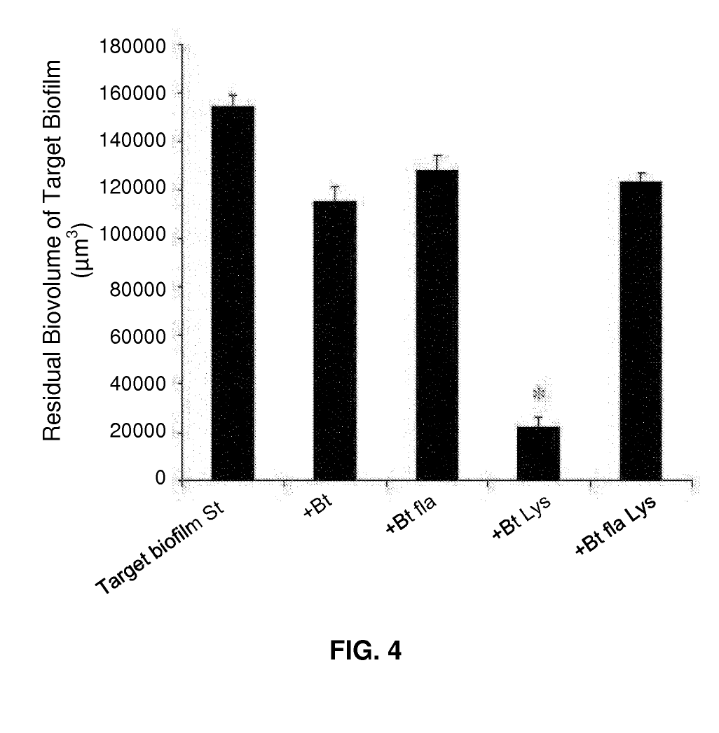

Only the results obtained with Bacillus thuringiensis 407 pHT50 are depicted (FIGS. 3A to 3E and FIG. 4), but similar results were not obtained with Bacillus subtilis.

To demonstrate the stability/repeatability of the obtained results, FIGS. 3A to 3E show, for each experiment, the results obtained for three wells of Staphylococcus aureus.

FIG. 4 shows the quantification (biovolume in μm³) of the residual biofilm of Staphylococcus aureus in the presence or not of a cocktail of swimming microorganisms, producing or not an antimicrobial product.

FIG. 3A shows a biofilm of 24-hour Staphylococcus aureus GFP. The biofilm has a thickness of 30 μm and a visual and structural homogeneity in all of its dimensions.

In FIG. 3B, the same biofilm of 24-hour Staphylococcus aureus GFP was subjected to a cocktail of bacteria comprising solely Bacillus thuringiensis 407.

FIG. 3C shows that one does not see any activity on this same biofilm of 24-hour Staphylococcus aureus GFP of a filtrate of Bacillus thuringiensis 407 pHT50. Thus, the quantity of lysostaphin contained in the supernatant of the cocktail is not sufficient to destructure the target biofilm. This applies similarly to the filtrate of the Bacillus thuringiensis 407 Δfla pHT50, which exhibits no activity on the target biofilm.

Similarly, the interaction of the biofilm with a cocktail of non-swimming bacteria producing lysostaphin (Bacillus thuringiensis 407 Δfla pHT50) does not induce a visible effect on the biofilm, which after 24 hours continues to persist (FIG. 3E).

The most spectacular effect observed is that obtained by interaction, always with 24 hours, with Bacillus thuringiensis 407 pHT50 (FIG. 3D). The production and release of lysostaphin by the swimming bacteria enable one to eradicate all of the biofilm in a short amount of time.

The quantitative results of FIG. 4 clearly confirm the results of FIGS. 3A to 3E, namely that the motile bacteria producing lysostaphin allow rapid destruction of the biofilm. The asterisk indicates a difference in biovolume that is statistically different from that of the non-treated biofilm (P<0.05). The biovolume of the Staphylococcus aureus biofilm treated with motile lysostaphin-producing strains is about 6 times lower than the biovolume of the Staphylococcus aureus biofilm treated with lysostaphin-producing but non-motile strains, showing the contribution made by swimming in regard to treating the target biofilm.

### 2—Example 2

### Elimination of a Staphylococcus Aureus Biofilm by a Microorganism Cocktail Comprising Swimming Bacteria Bacillus Thuringiensis not Producing any Antimicrobial Product in Combination with an Exogenous Antimicrobial Compound: Lysostaphin

The active compound may be an antimicrobial compound (chemical disinfectant, active biomolecules) or a dispersant agent (surfactants, enzymes, etc.).

In the following example, the active compound is lysostaphin, an autolysine specific to Staphylococcus aureus, whose effectiveness is improved by pretreating the target biofilms with a cocktail of swimming bacteria not producing antimicrobial compounds.

Material and Method

The strains of bacteria used for these experiments correspond to strains of Staphylococcus aureus RN4220 GFP and Bacillus thuringiensis 407 described in Table I.

The target biofilms of Staphylococcus aureus RN4220 GFP cultivated in microplates and the Bacillus thuringiensis 407 cultures used are obtained according to the method described previously.

On a microplate containing 24-hour biofilms of Staphylococcus aureus RN4220 GFP having a thickness of more than 30 μm, one carefully removes 250 μL of supernatant from each well. 250 μL of culture medium (control) or suspension of Bacillus thuringiensis 407 calibrated at 10⁸ cells/mL are then added into each well.

The Staphylococcus aureus biofilms in the presence or not of swimming bacteria are then incubated at 37° C. for 4 hours.

These target biofilms, sensitized or not for 4 hours by a cocktail of swimming bacteria, are then treated by adding into the wells 250 μL of lysostaphin in a concentration range of 0 to 0.5 μg/ml.

Interpretation of the Results

The same experimental device as the one described in the first experiment was used to quantify the effectiveness of treatment (comparison between the residual biovolume of the target biofilm during activity of the lysostaphin with or without pretreatment and a cocktail of swimming bacteria).

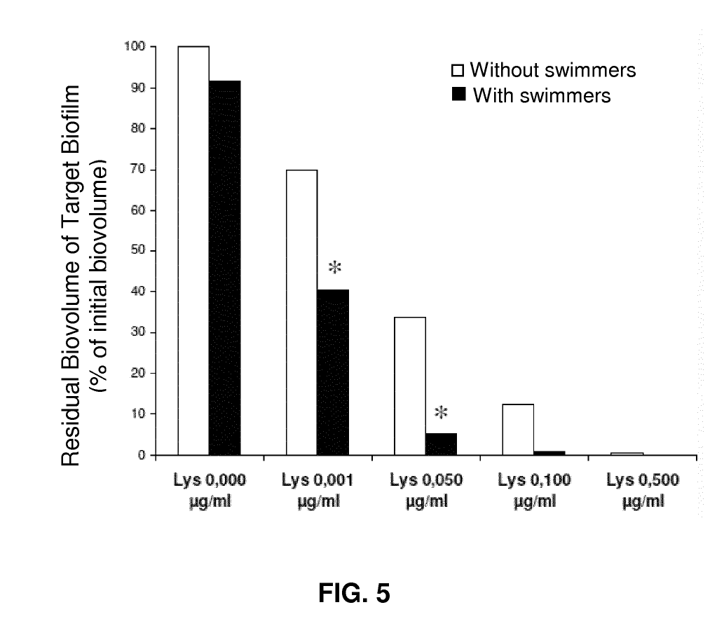

The results depicted in FIG. 5 show that while the antimicrobial compound alone does not allow eradication of the target biofilm (lysostaphin concentration <0.5 μg/ml), its effectiveness on the target biofilm is improved by the pretreatment with a cocktail of swimming bacteria (the asterisk indicates a statistically significant pretreatment effect, P<0.05).

### 3—Example 3

### Elimination of a Staphylococcus Aureus Biofilm by a Bacteria Cocktail Comprising Swimming Bacteria Bacillus Thuringiensis not Producing any Antimicrobial Product in Combination with a Non-Swimming Microorganism Producing Antimicrobial Compounds

Generally, the method described here allows one to highlight the effect on an undesirable biofilm of a swimming microorganism (not producing antimicrobial compounds) in combination with one (or more) non-swimming microorganisms but that produce an antimicrobial compound(s).

The microorganism not endowed with a swimming ability may produce bacteriocins (e.g., Lactococcus lactis, a producer of nisin), acids (lactic bacteria), other active biomolecules, etc.

The interaction example presented is that of the dissolution of 24-hour biofilms of Staphylococcus aureus RN 4220 GFP by motile strains of Bacillus thuringiensis in combination with non-swimming strains producing lysostaphin.

Material and Method

The strains of microorganisms used for these experiments correspond to strains of Staphylococcus aureus RN4220 GFP bacteria, Bacillus thuringiensis 407 (swimming bacteria) and Bacillus thuringiensis 407 Δfla pHT50 (non-swimming bacteria producing antimicrobial compounds) described in Table I.

The Staphylococcus aureus RN4220 GFP target biofilms cultivated in microplates and the cultures of Bacillus thuringiensis 407 and Bacillus thuringiensis 407 Δfla pHT50 used are obtained according to methods previously described.

On a microplate containing the 24-hour biofilms of Staphylococcus aureus RN4220 GFP having a thickness greater than 30 μm, one carefully removes 250 μL of supernatant from each well.

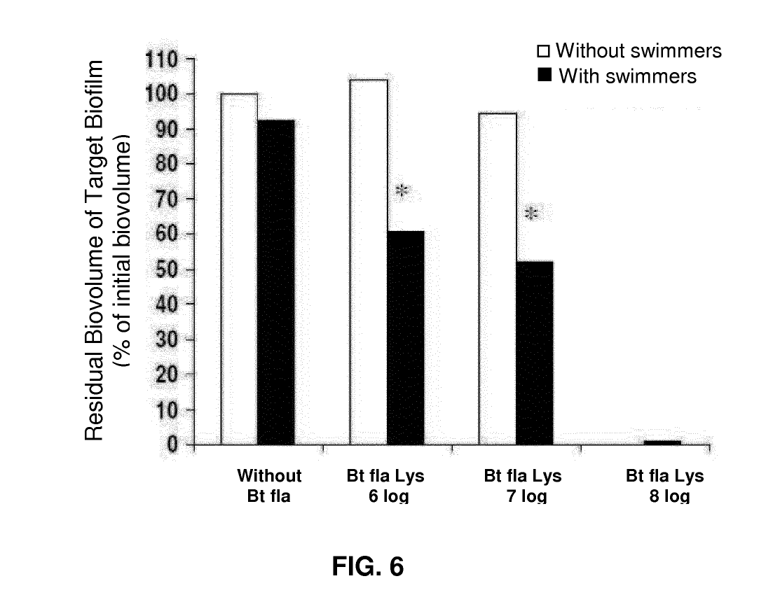

250 μL of the culture medium (control, indicated as “without Bt Δfla” in FIG. 6) or of the suspension of Bacillus thuringiensis 407 calibrated to 10⁸ cells/mL are then added to each well.

The Staphylococcus aureus biofilms in the presence or not of swimming bacteria are then incubated at 37° C. for 4 hours.

These target biofilms, sensitized or not by a cocktail of swimming bacteria, are then placed into contact with 250 μL of a suspension containing 6, 7, or 8 log/ml of non-motile bacteria producing a specific antimicrobial agent, lysostaphin (the Bacillus thuringiensis 407 Δfla pHT50 strain indicated as “Bt Δfla Lys 6 log,” “Bt Δfla Lys 7 log,” and “Bt Δfla Lys 8 log” in FIG. 6).

After one hour of interaction, the supernatant of the biofilms is replaced by 250 μL of a sterile culture medium, and the biofilms are incubated at 37° C. for 15 hours.

As done previously, the residual biofilms of the target pathogen are then quantified by calculating the biovolume based on a series of images obtained by CLSM.

Interpretation of the Results

The same experimental device as the one described in the first experiment was used to quantify the effectiveness of treatment (comparison between the residual biovolume of the target biofilm during the activity of the cocktail of non-swimming microorganisms producing lysostaphin, with or without pretreatment and a cocktail of swimming microorganisms).

The results depicted in FIG. 6 show that while the target biofilm is not eradicated by the cocktail of non-swimming but lysostaphin-producing bacteria (concentration <8 log/ml of Bacillus thuringiensis 407 Δfla pHT50), the pretreatment of the biofilm using a cocktail of swimming bacteria allowed one to improve the effectiveness of the treatment (the asterisk indicates a statistically significant pretreatment effect on the deconstruction of the target biofilm, P<0.05).

### 4—Example 4

### Elimination of a Staphylococcus Aureus Biofilm by a Microorganism Cocktail Comprising Swimming Bacteria Bacillus Thuringiensis not Producing any Antimicrobial Product and Swimming Bacteria Bacillus Licheniformis not Producing any Antimicrobial Product in Combination with an Exogenous Antimicrobial Compound: Benzalkonium Chloride

In the following example, the active compound is benzalkonium chloride, a biocide frequently used in hospitals and industrial sites.

Two strains of different swimming bacteria are used:
The strain of swimming bacteria Bacillus thuringiensis 407 (Bt) as well as the corresponding mutant non-swimming strain 407 Δfla pHT50 (Bt Δfla, negative control) described in Table 1 above. These bacteria have a diameter of about 1.5 μm.
The strain of swimming bacteria Bacillus licheniformis LMG7560 (designated by the code Bl) (available from the www.belspo.be/bcma collection), having a diameter of less than 1 μm and a swimming ability estimated by microscopy that is approximately twice as fast as the Bacillus thuringiensis 407 strain.

Material and Methods

The target biofilms of Staphylococcus aureus RN4220 GFP cultivated in microplates and bacilli cultures used are obtained according to the method previously described for Bacillus thuringiensis 407.

On a microplate containing 24-hour biofilms of Staphylococcus aureus RN4220 GFP having a thickness greater than 30 μm, one carefully removes 250 μL of supernatant from each well. 250 μL of culture medium (control) or suspension of:
Bt
BtΔfla
Bl
or Bt+Bl at equal concentrations,
   calibrated at 10⁸ cells/mL are then added to each well.

The Staphylococcus aureus biofilms in the presence or not of bacteria are then incubated at 37° C. for 4 hours to allow infiltration of swimming bacteria. The supernatants are eliminated prior to placement into contact with the biocide.

These target biofilms are then treated by adding to the wells 200 μL of C14 benzalkonium chloride (BAC, Fluka, Buchs, Switzerland) at a concentration of 750 ppm, or 200 μl of 150 M sodium chloride (NaCl) (“non-treated” biofilm.

After 5 minutes of contact at 20° C., 200 μL of a neutralizing solution (3 g/l L-a-phosphatidylcholine, 30 g/l Tween 80, 5 g/l sodium thiosulfate, 1 g/l L-histidine, 30 g/l saponin) are added to the wells to block the biocide activity.

The biofilms are then mechanically disaggregated using a micropipette cone and the collected suspension is immediately dispersed in 5 ml of the neutralizing solution.

The surviving S. aureus are counted on TSA agar after serialized dilutions in 150-mM NaCI and incubation for 24 hours at 37° C.

The log 10 reductions of the S. aureus bacteria are calculated by comparing the relationship of the surviving ones in the disinfected biofilms to the population of non-treated biofilms.

Interpretation of the Results

The negative controls, namely those having been subjected to the treatment by the non-swimming BtΔfla strain or not having been subjected to any treatment by the benzalkonium chloride, gave comparable results.

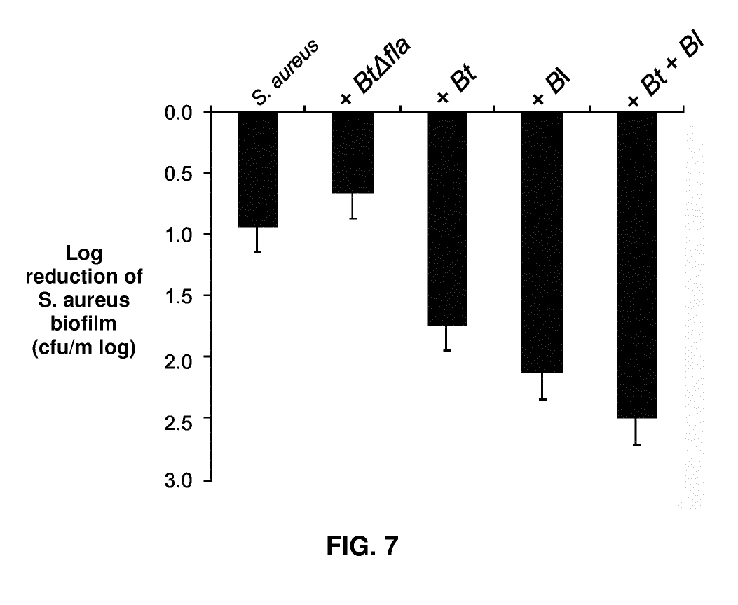

FIG. 7 shoes the results obtained in terms of log reduction of the biofilms. In this figure, the bars represent standard errors based on the 16 values obtained in 5 independent experiments.

One observes here that the log reduction of the biofilms increases significantly when the benzalkonium chloride treatment was preceded by a treatment with swimming bacteria, be it with a strain of Bacillus thuringiensis (Bt) or a strain of Bacillus licheniformis (Bl).

One also notes that pretreatment with a microorganism cocktail comprising these two strains (Bt+Bl) caused a greater reduction of the biofilm than each of these strains implemented separately.

### 5—Example 5

### Elimination of a Staphylococcus Aureus Biofilm by a Microorganism Cocktail Comprising Swimming Bacteria Bacillus Thuringiensis not Producing any Antimicrobial Product and Swimming Bacteria Bacillus Licheniformis not Producing any Antimicrobial Product, of Two Different Strains, in Combination with an Exogenous Antimicrobial Compound: Benzalkonium Chloride

The experiment of Example 4 above was reproduced by using two different strains of Bacillus licheniformis: strain LMG 7560, described above, referred to in this example by code Bl1, and the other, also swimming, strain LMG 7559, referred to as Bl2 (also available in the www.belspo.be/bcm collection).

These two strains were tested in isolation, as well as when blended, and when blended, each with the strain Bacillus thuringiensis 407 (Bt). A blend of these three swimming strains (Bt+Bl1+Bl2) was also tested.

The results, in terms of log reduction of the biofilms, are depicted in Table 2 below.

TABLE 2
Effect on the elimination of biofilm by the blend of several
swimming strains having different properties

| | | Log reduction (+/−0.2) |
|---|---|---|
| | Nothing added | 0 |
| Treatment with C14 | S. aureus | −0.9 |
| benzalkonium chloride | BtΔfla | −0.7 |
| | Bt | −2.1 |
| | Bl1 | −2.1 |
| | Bl2 | −2.0 |
| | Bl1 + Bl2 | −2.0 |
| | Bt + Bl1 | −2.5 |
| | Bt + Bl2 | −2.7 |
| | Bt + Bl1 + Bl2 | −2.8 |

As in the preceding example, one observes from these results that the blending of two swimming strains having different properties, of which one strain having bacteria of a larger diameter (Bt) and a strain of bacteria having a greater displacement speed in the biofilm (Bl1 and/or Bl2) exhibit, in combination with benzalkonium chloride, a much higher effectiveness than each of these strains independently.

### BIBLIOGRAPHY

Bridier A, F. Dubois-Brissonnet, A. Boubetra, V. Thomas, R. Briandet. 2010. The biofilm architecture of sixty opportunistic pathogens deciphered by a high throughput CLSM method, Journal of Microbiological Methods 82 (2010) 64-70.
Gaier W, Vogel R F, Hammes W P. Cloning and expression of the lysostaphin gene in Bacillus subtilis and Lactobacillus casei. Lett Appl Microbiol. 1992 March; 14(3): 72-6
Guérout-Fieury A M, Shazand K, Frandsen N, Stragier P, Antibiotic resistance cassettes for Bacillus subtilis. Gene. 1995 Dec. 29; 167(1-2): 335-6.
Houry A, Briandet R, Aymerich S, Gohar M. Involvement of motility and flagella in Bacillus cereus biofilm formation. Microbiology. 2010 April; 156(Pt 4): 1009-18.
Lereclus D, Vallade M, Chaufaux J, Arantes O, Rambaud S. Expansion of insecticidal host range of Bacillus thuringiensis by in vivo genetic recombination. Biotechnology (NY). 1992 April; 10(4): 418-21
Malone C L, Baies B R, Lauderdale K J, Thoendel M, Kavanaugh J S, Horswill A R. Fluorescent reporters for Staphylococcus aureus. J Microbiol Methods. 2009; 77(3): 251-60
Salamitou S, Ramisse F, Brehelin M, Bourguet D, Gilois N, Gominet M, Hernandez E, Lereclus D. The plcR regulon is involved in the opportunistic properties of Bacillus thuringiensis and Bacillus cereus in mice and insects. Microbiology. 2000 November; 146: 2825-32.

1. Method for eliminating a biofilm of microorganisms preexisting on an inert surface, comprising:
subjecting said biofilm to a first microorganism cocktail comprising at least a one population of swimming microorganisms whose kinetic energy is such that they are able to cross said biofilm in the plane and thickness, and
subjecting said biofilm to at least one antimicrobial product directed against at least one microorganism of the biofilm to be eliminated.

2. Method according to claim 1, wherein the swimming microorganisms of the first microorganism cocktail synthesize at least one antimicrobial product directed against at least one microorganisms of the biofilm to be eliminated.

3. Method according to claim 1, wherein the cocktail of microorganisms used also comprises non-swimming microorganisms which synthesize at least one antimicrobial product directed against at least one microorganism of the biofilm to be eliminated.

4. Method according to claim 1 further comprising subjecting the biofilm, previously treated with the first microorganism cocktail, to a second microorganism cocktail comprising at least non-swimming microorganisms which synthesize at least one antimicrobial product directed against at least one microorganism of the biofilm to be eliminated.

5. Method according to claim 1, wherein the first microorganism cocktail also comprises at least one antimicrobial directed against at least one microorganism of the biofilm to be eliminated.

6. Method according to claim 1, further comprising subjecting the biofilm, previously treated with the first microorganism cocktail, to at least one biological or chemical antimicrobial directed against at least one microorganism of the biofilm to be eliminated.

7. Method according to claim 1, wherein the swimming microorganisms of the first microorganism cocktail are selected from the bacteria Bacillus thuringiensis, Bacillus licheniformis, Bacillus subtilis, or Serpens flexibilis.

8. Method according to the microorganism cocktail comprises at least a first strain of swimming microorganism of large size moving at a slower speed in said biofilm, and a second strain swimming microorganism of smaller size moving at a greater speed in said biofilm.

9. Method according to claim 8, wherein the ratio of the size of the swimming microorganisms of the first strain to the size of the swimming microorganisms of the second strain is greater than or equal to 1.5.

10. Method according to claim 8, the ratio of the displacement speed in said biofilm of the swimming microorganisms of the second strain to the displacement speed in said biofilm of the swimming microorganisms of the first strain is greater than or equal to 1.5.

11. Method according to claim 8, the first strain belongs to the Bacillus thuringiensis species and the second strain belongs to the Bacillus licheniformis species.

12. Method according to claim 9, wherein the ratio of the displacement speed in said biofilm of the swimming microorganisms of the second strain to the displacement speed in said biofilm of the swimming microorganisms of the first strain is greater than or equal to 1.5.

13. Method according to claim 4, wherein the second microorganism cocktail also comprises at least one antimicrobial directed against at least one microorganism of the biofilm to be eliminated.

14. Method according to claim 4, further comprising subjecting the biofilm, previously treated with the second microorganism cocktail, to at least one biological or chemical antimicrobial directed against at least one microorganism of the biofilm to be eliminated.

15. Method according to claim 4, wherein the non-swimming microorganisms belong to the Bacillus thuringiensis species.

16. Method according to claim 4, wherein the non-swimming microorganisms produce lysostaphin.

17. Method according to claim 1, wherein the swimming microorganisms are swimming bacteria.

18. Method according to claim 1 wherein the biofilm to be eliminated is a biofilm formed by Staphylococcus aureus.
